(19) United States
(12) Patent Application Publication
(10) Pub. No.: US 2021/0288511 A1
(43) Pub. Date: Sep. 16, 2021

(54) CHARGE AND DISCHARGE CONTROL METHOD, BATTERY-MOUNTED DEVICE, MANAGEMENT SYSTEM, MANAGEMENT METHOD, MANAGEMENT SERVER, AND NON-TRANSITORY STORAGE MEDIUM

(71) Applicant: KABUSHIKI KAISHA TOSHIBA, Tokyo (JP)

(72) Inventors: Yumi FUJITA, Tokyo (JP); Tomokazu MORITA, Funabashi Chiba (JP); Nobukatsu SUGIYAMA, Kawasaki Kanagawa (JP)

(73) Assignee: KABUSHIKI KAISHA TOSHIBA, Tokyo (JP)

(21) Appl. No.: 17/007,215

(22) Filed: Aug. 31, 2020

(30) Foreign Application Priority Data
Mar. 13, 2020 (JP) 2020-043771

(51) Int. Cl. H02J 7/00

(52) U.S. Cl. CPC H02J 7/0048; H02J 7/005

(57) ABSTRACT

With a charge and discharge control method according to one embodiment, measurement data regarding a parameter relating to a battery of a battery-mounted device at the time of battery charge or discharge, is acquired. Furthermore, with the charge and discharge control method, a control instruction relating to the charge and discharge of the battery and corresponding to at least a result of a diagnosis of a deterioration state of the battery based on the measurement data, is received from the outside of the battery-mounted device. With the charge and discharge control method, the charge and discharge of the battery is controlled based on the received control instruction.

### CROSS-REFERENCE TO RELATED APPLICATIONS

This application is based upon and claims the benefit of priority from Japanese Patent Application No. 2020-043771, filed Mar. 13, 2020, the entire contents of which are incorporated herein by reference.

### FIELD

Embodiments relate to a charge and discharge control method, a battery-mounted device, a management system, a management method, a management server, and a non-transitory storage medium.

### BACKGROUND

In recent years, a chargeable/dischargeable battery (storage battery) has been mounted on battery-mounted devices, such as smart phones, vehicles, stationary power source apparatuses, and drones. In such a battery-mounted device, one or more secondary batteries, such as lithium ion batteries, are provided so as to constitute the above-described chargeable/dischargeable battery. It is known that repeated charging and discharging deteriorates the above-described chargeable/dischargeable battery constituted by one or more secondary batteries; for example, the capacitance of the battery becomes decreased.

In a battery-mounted device onto which the above-described battery is mounted, it is requested that a person (hereinafter, “administrator”) other than a user of a battery-mounted device who is responsible for batteries, such as a provider of the battery-mounted device, is able to appropriately ascertain the deterioration state of the battery. It is also required that occurrence of battery safety problems be prevented in advance by an administrator other than a user of the battery.

### BRIEF DESCRIPTION OF THE DRAWINGS

FIG. 1 is a block diagram schematically showing management system according to a first embodiment.

FIG. 2 is a schematic diagram explaining internal state parameters, etc. of a battery.

FIG. 3 is a schematic diagram showing an example of data serving as criteria for a relationship between battery safety and two diagnosis items, which are a positive electrode capacitance retention ratio and a negative electrode capacitance retention ratio.

FIG. 4 is a schematic diagram explaining an example of a diagnosis of a remaining life span of a battery.

FIG. 5 is a schematic diagram explaining another example of the diagnosis of a remaining life span of a battery differing from the example shown in FIG. 4.

FIG. 6 is a schematic diagram showing an example of generation of a control instruction based on the criteria data shown in FIG. 3, and control of a battery based on the control instruction.

FIG. 7 is a flowchart illustrating an example of processing performed by a controller of a battery-mounted device and a management server according to the first embodiment.

FIG. 8 is a block diagram schematically showing a management system according to a second embodiment.

FIG. 9 is a flowchart showing an example of processing performed by a controller of a battery-mounted device and a management server according to the second embodiment.

### DETAILED DESCRIPTION

With a charge and discharge control method according to one embodiment, measurement data regarding a parameter relating to a battery of a battery-mounted device at the time of battery charge or discharge, is acquired. Furthermore, with the charge and discharge control method, a control instruction relating to the charge and discharge of the battery and corresponding to at least a result of a diagnosis of a deterioration state of the battery based on the measurement data, is received from the outside of the battery-mounted device. With the charge and discharge control method, the charge and discharge of the battery is controlled based on the received control instruction.

A battery-mounted device according to one embodiment includes a controller that executes the above charge and discharge control method, and a battery for which charge and discharge is controlled by the controller.

A management system according to one embodiment includes the above-mentioned battery-mounted device, and a management server equipped with a processor. The processor of the management server generates a control instruction corresponding to a diagnosis result of a deterioration state of a battery, and outputs the generated control instruction to the battery-mounted device.

A non-transitory storage medium according to one embodiment stores a charge and discharge control program causing a computer of a battery-mounted device to execute the above-described charge and discharge control method.

In a management method according to one embodiment, a diagnosis result of a battery deterioration state based on measurement data regarding the parameter relating to the battery of the battery-mounted device at the time of battery charge or discharge, is acquired. Furthermore, with the management method, a control instruction relating to the charge and discharge of a battery corresponding to at least a diagnosis result of a deterioration state is generated. With the management method, the generated control instruction is output to the battery-mounted device.

A management server according to one embodiment includes a processor that executes the above-described management method.

A non-transitory storage medium according to one embodiment stores a management program that causes an external computer of the battery-mounted device to execute the above-described management method.

Hereinafter, the embodiments will be described with reference to the accompanying drawings.

### First Embodiment

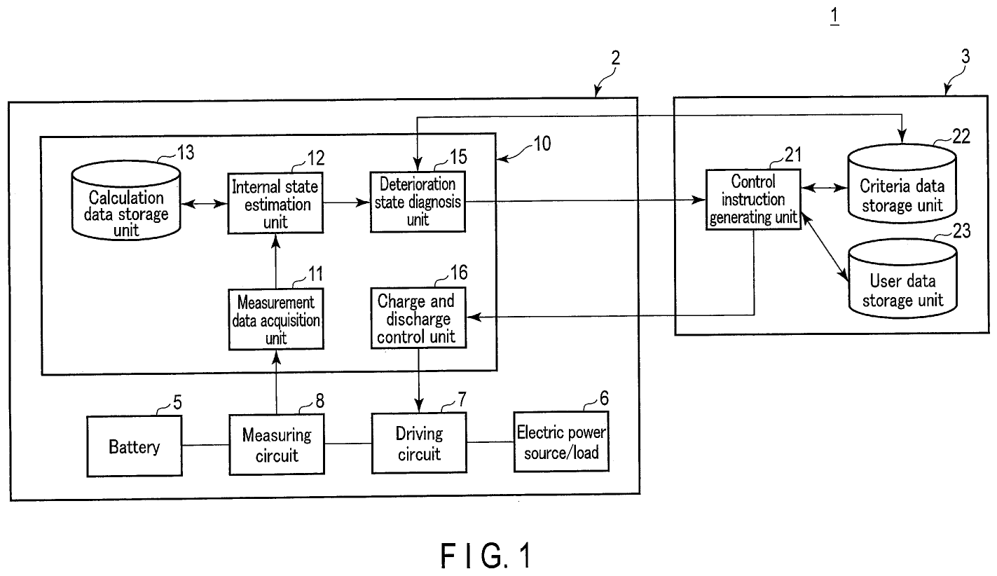

The first embodiment will be described below. FIG. 1 is a block diagram schematically showing a management system according to the first embodiment. The management system 1 includes a battery-mounted device 2 and a management server 3.

The battery-mounted device 2 includes a battery (storage battery) 5, an electric power source and a load (together indicated by reference number 6), a drive circuit 7, a measuring circuit 8, and a controller 10. The battery 5 may be constituted by either a single unit cell or a battery module comprised of a plurality of unit cells. If the battery 5 is a battery module, at least either of a serial connection structure in which the plurality of unit cells are electrically connected in series, or a parallel connection structure in which the plurality of unit cells are electrically connected in parallel, is formed in the battery module. The unit cells constituting the battery 5 are a secondary battery such as a lithium ion secondary battery. Examples of the battery-mounted device 2 are a smart phone, a vehicle, a stationary power source apparatus, and a drone, and examples of the vehicle as the battery-mounted device are an electric vehicle, a plug-in hybrid electric vehicle, and an electric motor bike.

The battery 5 is chargeable and dischargeable. The battery 5 is charged by supplying electric power from the electric power source to the battery 5. The electric power discharged from the battery 5 is supplied to the load. In the example shown in FIG. 1, the electric power source and the load are mounted on the battery-mounted device 2; however, at least either of the electric power source or the load may be provided from the outside of the battery-mounted device 2. In the battery-mounted device 2, the driving of the drive circuit 7 is controlled so as to control the charge and discharge of the battery 5. The measuring circuit 8 detects and measures parameters relating to the battery 5 when the battery 5 is charged or discharged. The detection of parameters by the measuring circuit 8 is periodically performed at predetermined timing. The parameters relating to the battery 5 include an electric current flowing in the battery 5, a voltage between the positive and negative electrode terminals of the battery 5, and a temperature of the battery 5. For this reason, the measuring circuit 8 includes an ammeter that measures currents, a voltage meter that measures voltages, and a temperature sensor that measures temperatures, for example.

The controller 10 constitutes a computer, and includes a processor and a storage medium. The processor includes a CPU (central processing unit), a GPU (graphics processing unit), an ASIC (application specific integrated circuit), a microcomputer, an FPGA (field programmable gate array), or a DSP (digital signal processor), etc. The storage medium may include an auxiliary storage apparatus, in addition to a main storage apparatus such as a memory. The storage medium is for example a magnetic disk, an optical disk (CD-ROM, CD-R, DVD, etc.), a magneto-optical disk (MO, etc.), or a semiconductor memory. Both the processor and the storage medium included in the controller 10 may number one or more. The processor of the controller 10 performs processing by executing a program, etc. stored on the storage medium, etc. The program executed by the processor of the controller 10 may be stored in a computer (server) connected via a network such as the Internet, or on a server space within a cloud environment. In each of these cases, the processor downloads the program via the network.

The controller 10 includes a measurement data acquisition unit 11, an internal state estimation unit 12, a calculation data storage unit 13, a deterioration state diagnosis unit 15, and a charge and discharge control unit 16. The measurement data acquisition unit 11, the internal state estimation unit 12, the deterioration state diagnosis unit 15, and the charge and discharge control unit 16 perform a part of the processing performed by the processor, etc. of the controller 10. The storage medium of the controller 10 functions as the calculation data storage unit 13.

The management server 3 is provided outside the battery-mounted device 2. Furthermore, the management server 3 includes the control instruction generating unit 21, a criteria data storage unit 22, and a user data storage unit 23. In one example, the management server 3 is a server communicable with the controller 10 of the battery-mounted device 2 via a network. In this case, the management server 3 includes a processor and a storage medium, similarly to the controller 10.

Furthermore, the control instruction generating unit 21 performs a part of the processing performed by the processor, etc. of the management server 3, and the storage medium of the management server 3 functions as the criteria data storage unit 22 and the user data storage unit 23. In another example, the management server 3 is a cloud server configured in a cloud environment. In this case, the infrastructure of the cloud environment is comprised of a virtual processor such as a virtual CPU, and a cloud memory. A part of the processing performed by the virtual processor is performed by the control instruction generating unit 21. The cloud memory functions as the criteria data storage unit 22 and the user data storage unit 23.

The criteria data storage unit 22 and the user data storage unit 23 may be provided in a computer separate from the controller 10 and the management server 3. In this case, the management server 3 is connected to the computer where the criteria data storage unit 22 and the user data storage unit 23, etc. are provided, via a network.

The measurement data acquisition unit 11 acquires measurement values of the parameters relating to the battery 5 measured in the measuring circuit 8. The measurement data acquisition unit 11 periodically acquires the measurement values of the parameters relating to the battery 5 at predetermined timing. Accordingly, the measurement data including temporal change (time history) in the parameters relating to the battery 5 is acquired by the measurement data acquisition unit 11. The measurement data includes temporal changes (time history) in an electric current flowing in the battery 5, temporal changes (time history) in a voltage between the terminals of the battery 5, and temporal changes (time history) in a temperature of the battery 5. The measurement data acquisition unit 11 acquires a charge condition or a discharge condition at the time of measuring the parameters relating to the battery 5, in addition to the measurement data. The charge condition includes an SOC (state of charge) of the battery 5 at the times when the charge starts and finishes, and a temperature range of the battery 5 at the time of charge, and so on. Similarly, the discharge condition includes an SOC (state of charge) of the battery 5 at the times when the discharge starts and finishes, and a temperature range of the battery 5 at the time of discharge, and so on.

The measurement data acquisition unit 11 acquires, as measurement data, data indicating the relationships of each of the current and the voltage of the battery 5 with respect to the charging time (discharging time) of the battery 5, based on a measurement result of the current and voltage of the battery 5. Furthermore, the measurement data acquisition unit 11 may acquire, as measurement data, data indicating the relationship of the current and the voltage of the battery 5 with respect to either the charge amount (discharge amount) of the battery 5 from the time when charging (discharging) starts or the SOC of the battery 5. The SOC of the battery 5 indicates the ratio of the remaining capacitance of the battery 5 to the full charge capacitance of the battery 5, which falls between 0% and 100%. The SOC can be calculated using the above-described measurement data and the charge and discharge history, etc. of the battery 5. As a method of calculating the SOC of the battery 5, an electric current multiplication method, a calculation using the relationship between the voltage between terminals and the SOC of the battery 5, and an estimation method using a Kalman filter may be adopted. In the battery 5, a state in which the voltage between the positive electrode terminal and the negative electrode terminal becomes a voltage value Vα1 is defined as a state in which the SOC becomes 0%, and a state in which the voltage between the terminals becomes a voltage value Vα2 which is larger than the voltage value Vα1 is defined as a state in which the SOC becomes 100%.

The internal state estimation unit 12 receives the above-described measurement data from the measurement data acquisition unit 11 and the charge condition or the discharge condition. Then, the internal state estimation unit 12 estimates the internal states and the battery characteristics of the battery 5 based on the measurement data. In the present embodiment, the internal state estimation unit 12 analyzes the measurement data representing the relationships of each of a voltage and an electric current of the target battery 5 with respect to a charging time (discharging time) of the battery 5. In other words, each of the temporal change in the voltage of the battery 5 and the temporal change in the current of the battery 5 is analyzed by the internal state estimation unit 12.

In one example, the internal state estimation unit 12 may perform an analysis on a charging curve of the battery 5 included in the measurement data (i.e., a temporal change of each of the charging voltage and the charging current of the battery 5 during charging), in other words, a charging curve analysis. The internal state estimation unit 12 estimates the internal state parameters based on the measurement data so as to estimate the internal state of the battery 5. Herein, the internal state parameters include the following: a positive electrode capacitance (or a positive electrode mass), a negative electrode capacitance (or a negative electrode mass), an initial charge amount of a positive electrode, an initial charge amount of a negative electrode, and internal resistance. A shift of operation window (SOW), which represents a difference between the initial charge amount of the positive electrode and the initial charge amount of the negative electrode, is also included in the internal state parameters.

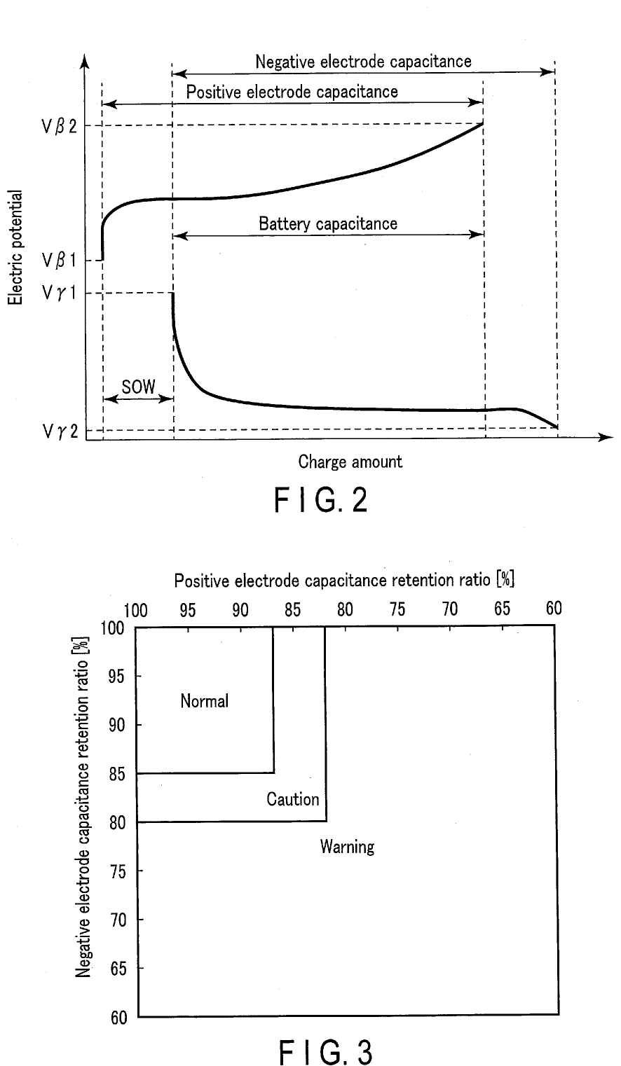

FIG. 2 is a schematic diagram explaining the internal state parameters, etc. of the battery. As shown in FIG. 2, the positive electrode capacitance is a charge amount of the battery 5 between the initial charge amount and the upper limit charge amount of the positive electrode. Furthermore, the charge amount of the positive electrode in the state where the positive electrode potential (electric potential of the positive electrode terminal) becomes Vβ1 is defined as the initial charge amount, and the charge amount of the positive electrode in the state where the positive electrode potential (electric potential of the positive electrode terminal) becomes Vβ2, which is higher than Vβ1, is defined as the upper limit charge amount. The negative electrode capacitance is a charge amount of the battery 5 between the initial charge amount and the upper limit charge amount of the negative electrode. Furthermore, the charge amount of the negative electrode in the state where the negative electrode potential (electric potential of the negative electrode terminal) becomes Vγ1 is defined as the initial charge amount, and the charge amount of the negative electrode in the state where the negative electrode potential (electric potential of the negative electrode terminal) becomes Vγ2, which is lower than Vγ1, is defined as the upper limit charge amount. When the battery 5 deteriorates due to repetitive charging and discharging, both the positive electrode capacitance and the negative electrode capacitance of the battery 5 reduce from their levels at the start of use of the battery 5. If the battery 5 deteriorates, the SOW of the battery 5 changes in comparison to those at the time when the battery 5 starts being used.

The internal state estimation unit 12 estimates the battery characteristic parameters of the battery 5 based on the estimated internal state parameters, so as to estimate the battery characteristics of the battery 5. The battery characteristic parameters include an open circuit voltage (OCV), an OCV curve, and a battery capacitance, for example. Furthermore, the aforementioned internal resistance of the battery 5 may be included in the battery characteristic parameters. Herein, the OCV curve is a function representing a relationship between a parameter other than the OCV of the battery 5 and an OCV, for example a function representing a relationship between the SOC or the charge amount of the battery 5 and the OCV. The battery capacitance is a charge amount of the battery 5 in the overlapping portion between the range of the positive electrode capacitance and the range of the negative electrode capacitance (see FIG. 2).

In the calculation data storage unit 13, the calculation data used for calculating estimates of the internal states and the battery characteristics is stored. The internal state estimation unit 12 reads the calculation data necessary for estimating the internal state, etc. from the calculation data storage unit 13. Examples of the calculation data include the following: a function representing an open circuit potential (OCP) of the positive electrode corresponding to the SOC of the positive electrode, a function representing an OCP of the negative electrode corresponding to the SOC of the negative electrode, an upper limit voltage and a lower limit voltage imposed on the OCV, an intermediate estimated value of a parameter for acquiring a final estimation result of a parameter of the battery 5, and so on. The internal state estimation unit can store, among the estimated parameters, parameters necessary for future parameter estimation, in the calculation data storage unit 13. The estimation of the internal states and battery characteristics of the battery 5 based on the charging curve analysis is performed in a manner similar to that disclosed in Reference Document 1 (Jpn. Pat. Appln. KOKAI Publication No. 2018-147827) for example. Thus, the above-described internal state parameters and battery characteristic parameters of the battery 5 are estimated in a manner similar to the estimation disclosed in Reference Document 1.

The deterioration state diagnosis unit 15 receives an estimation result of the internal states and battery characteristics of the battery 5 from the internal state estimation unit 12. Furthermore, the deterioration state diagnosis unit 15 diagnoses the deterioration state of the battery 5 based on one of the estimated internal state parameters and battery characteristic parameters. The diagnosis of the deterioration state of the battery 5 includes a safety diagnosis of the battery 5, and a diagnosis of a remaining life span of the battery 5, for example. Herein, in the criteria data storage unit 22 of the management server 3, criteria data which serves as criteria for the relationship between one or more diagnosis items and the deterioration state of the battery 5 is stored. For example, the data serving as criteria for the relationship of the safety of the battery 5 with respect to one or more diagnosis items, and the data serving as criteria for the relationship of the remaining life span of the battery 5 with respect to one or more diagnosis items are stored in the criteria data storage unit 22. The deterioration state diagnosis unit 15 reads criteria data from the criteria data storage unit 22 via a network, etc. Furthermore, the deterioration state diagnosis unit 15 diagnoses the deterioration state of the battery 5 based on one of the estimated internal state parameters and battery characteristic parameters and the criteria data.

The diagnosis items in the deterioration state diagnosis include for example, the internal state parameters (such as a positive electrode capacitance, a negative electrode capacitance, an SOW, and internal resistance) and the battery characteristic parameters (such as a battery capacitance). The diagnosis items may include a parameter calculated using any of the internal state parameters or the battery characteristic parameters. In one example, either one of the positive electrode capacitance retention ratio which is a ratio of the estimated positive electrode capacitance to the positive electrode capacitance at the start of use, or the negative electrode capacitance retention ratio which is a ratio of the estimated negative electrode capacitance to the negative electrode capacitance at the start of use.

In the following, an example of the aforementioned criteria data (deterioration map) will be described. FIG. 3 is a schematic diagram showing an example of data serving as criteria for a relationship of battery safety with respect to two diagnosis items, which are a positive electrode capacitance retention ratio and a negative electrode capacitance retention ratio. In the diagnosis of the deterioration state of the battery 5 using the criteria data shown in FIG. 3, a positive electrode capacitance retention ratio and a negative electrode capacitance retention ratio from the estimated positive electrode capacitance and negative electrode capacitance. Then, based on the calculated positive and negative electrode capacitance retention ratios, and the criteria data, the safety of the battery 5 is diagnosed as “normal”, “caution”, and “warning”. For example, if the estimated negative electrode capacitance retention ratio is 75%, the safety of the battery 5 is diagnosed as “warning”. In the example shown in FIG. 3, the safety of the battery 5 is divided into three levels; however, it may be divided into five levels. The safety of the battery 5 may be indicated by a safety index, etc. In this case, the larger the safety index, the higher the safety of the battery 5, for example.

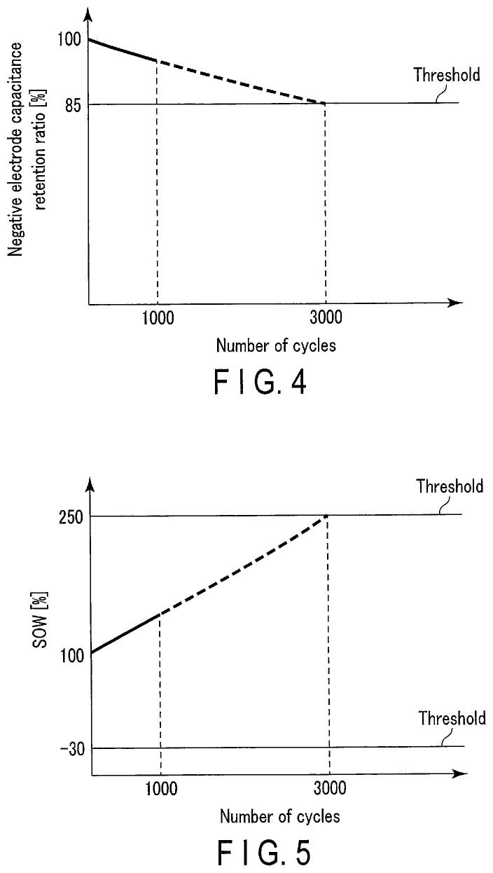

The diagnosis of the remaining life span of the battery included in the deterioration state diagnosis will be described. In the remaining life span diagnosis, a threshold of a diagnosis item corresponding to the end time of the life span of the battery 5 is used as criteria data. FIG. 4 is a schematic diagram explaining an example of the diagnosis of a remaining life span of the battery. In the example shown in FIG. 4, the negative electrode capacitance retention ratio is used as a diagnosis item, and in the criteria data used in the diagnosis, the threshold of the negative electrode capacitance retention ratio corresponding to the end time of the life span of the battery 5 is set at 85%. Then, at 1,000 cycles of the charging and discharging since the start of use of the battery 5, the diagnosis of remaining life span is conducted using the negative electrode capacitance retention ratio as a diagnosis item. Then, at 3,000 cycles of the charging and discharging since the start of use of the battery 5, it is diagnosed that the negative electrode capacitance retention ratio reaches the threshold of the criteria data (85%), and the life span of the battery 5 ends.

FIG. 5 is a schematic diagram explaining another example of the diagnosis of a remaining life span of the battery differing from the example shown in FIG. 4. In the example of FIG. 5, the SOW is used as a diagnosis item, and the SOW is indicated as 100% at the start of use. Furthermore, in the criteria data used for a diagnosis, two thresholds of the SOW corresponding to the end time of the life span of the battery 5 are set at 250% and −30%. Herein, in the example of FIG. 5, the arrival at either one of the two thresholds of the SOW is diagnosed as the end of the life span of the battery 5. Furthermore, if the SOW indicates a negative value, the direction of a difference between the initial charge amount of the positive electrode and the initial charge amount of the negative electrode is opposite to that at the start of use. In the example shown in FIG. 5, at 1,000 cycles of the charging and discharging since the start of use of the battery 5, the diagnosis of remaining life span is conducted using the SOW as a diagnosis item. Then, at 3,000 cycles of the charging and discharging since the start of use of the battery 5, it is diagnosed that the SOW reaches either one of the thresholds of the criteria data (250%), and the life span of the battery 5 ends.

The diagnosis result of the remaining life span is not necessarily indicated by the number of cycles counted since the start of use, and may be indicated by the number of cycles counted since a current point of time (at the time of diagnosis). The diagnosis result of remaining life span may be indicated by a time elapsed since the start of use or from a current point of time (at the time of diagnosis), for example 100 days or 10,000 hours. In the remaining life span diagnosis in the examples shown in FIGS. 4 and 5, the end time of the life span of the battery 5 is determined based on a threshold of a single diagnosis item; however, the end time of the life may be comprehensively determined based on two or more diagnosis items.

As described above, in the present embodiment, the internal states and the battery characteristics of the battery 5 are estimated based on the measurement data of the parameters related to the battery 5 (a current, a voltage, and a temperature, etc.) at the time of battery charge or discharge. Furthermore, the deterioration state of the battery 5 is diagnosed based on one of the estimated internal states or the battery characteristics. For this reason, the diagnosis result of the deterioration state is based on the measurement data. If the battery-mounted device 2 is a smart phone, etc., the aforementioned diagnosis of the deterioration state of the battery 5 based on the measurement data may be conducted by executing an application downloaded to the smart phone.

The deterioration state diagnosis unit 15 outputs the diagnosis result of the deterioration state to the management server 3. In other words, the diagnosis result of the deterioration state is output to the outside of the battery-mounted device 2. The control instruction generation unit 21 of the management server 3 acquires data indicating a diagnosis result of the deterioration state of the battery 5 by receiving the diagnosis result of the deterioration state from the battery-mounted device 2. The battery-mounted device 2 outputs, to the management server 3, the measurement data, the real-time SOC (remaining capacitance) of the battery 5 calculated based on the measurement data, the charging and discharging history of the battery 5, the charging condition or the discharging condition at the time of data measurement, and information relating to the estimated internal states and battery characteristics, in addition to the diagnosis result of the deterioration state. Thus, the control instruction generation unit 21 of the management server 3 can ascertain how the battery 5 has been used (use history) from a previous deterioration state diagnosis up until a current point of time (a current diagnosis of the deterioration state), in addition to the diagnosis result of the deterioration state. To the management server 3 of the battery-mounted device 2, an identifier of the battery 5 or the battery-mounted device 2 is output, and the identifier may be acquired by the control instruction generation unit 21 of the management server 3.

The control instruction generation unit 21 generates a control instruction regarding the charge and discharge of the battery 5 in correspondence to at least the diagnosis result of the deterioration state of the battery 5. Herein, the control instruction generation unit 21 reads, from the criteria data storage unit 22, the criteria data which serves as criteria for the relationship of the deterioration state of the battery 5 with respect to one or more diagnosis items. Furthermore, the control instruction generation unit 21 generates a control instruction based on a diagnosis result of the deterioration state of the battery 5 and the read criteria data. Furthermore, the control instruction generation unit 21 outputs the generated control instruction to the charge and discharge control unit 16 of the battery-mounted device 2. Thus, the charge and discharge control unit 16 of the controller 10 receives a control instruction relating to the charge and discharge of the battery 5 corresponding to at least a diagnosis result of a deterioration state of the battery 5. Accordingly, the control instruction is output from the control instruction generation unit 21 to the charge and discharge control unit 16, as a response to the diagnosis result of the deterioration state that has been output to the management server 3.

The charge and discharge control unit 16 controls the driving of the driving circuit 7 based on the received control instruction, and controls the charge and discharge of the battery 5. Thus, the controller 10 controls the charge and discharge of the battery 5 as a slave control apparatus having the management server 3 as a master. It is thereby possible to realize remote control of the charge and discharge of the battery 5 by the management server 3. Through the control of the charge and discharge of the battery, one of an electric current flowing in the battery being charged, and an upper limit of a voltage of the battery 5 during the charging, or a power output from the battery 5 during discharging, is adjusted.

In the present embodiment, in the case where the diagnosis result of the deterioration state of the battery 5 exceeds a permissible range, the control instruction generation unit 21 generates, as a control instruction, an instruction to suppress one of an electric current flowing in the battery being charged (e.g., a charging rate), a voltage of the battery being charged (e.g., an upper limit of a charging voltage), or a power output from the battery during the discharging, in comparison to the case where the diagnosis result is in the permissible scope, or an instruction is issued to stop the use of the battery 5 through cessation of battery charge and discharge. Thus, if the diagnosis result of the deterioration state exceeds the permissible scope, the charge and discharge control unit 16 suppresses, based on the received control instruction, one of an electric current flowing in the battery being charged, a voltage of the battery being charged, or a power output from the battery during discharging, in comparison to the case where the diagnosis result is in the permissible scope, or stops the use of the battery 5 through the cessation of the charge and discharge.

In one example, the control instruction generation unit 21 generates a control instruction regarding the charge and discharge of the battery 5 corresponding at least to the diagnosis result of the deterioration state of the battery 5, using the criteria data shown in FIG. 3. In this example, if the safety of the battery 5 falls under the category of “normal”, the control instruction generation unit 21 determines that the deterioration state is in a permissible range. If the safety of the battery 5 falls under the category of “caution”, the control instruction generation unit 21 generates an instruction to suppress, in comparison to the case where the diagnosis result is in the permissible scope (the case where the safety of the battery 5 falls under the category of “normal”), one of an electric current flowing in the battery being charged (e.g., a charging rate), a voltage of the battery being charged (e.g., an upper limit of a charging voltage), or a power output from the battery during discharging. If the safety of the battery 5 falls under the category of “warning”, the control instruction generation unit 21 generates an instruction to stop the use of the battery 5 through the cessation of battery charge and discharge.

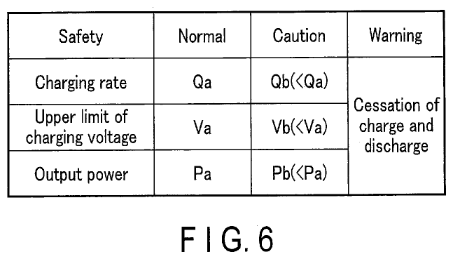

FIG. 6 is a schematic diagram showing an example of generation of a control instruction based on the criteria data shown in FIG. 3, and control of the battery based on the control instruction. The generation of a control instruction based on the criteria data shown in FIG. 3 and the control of the battery 5 based on the control instruction are performed as shown in the example of FIG. 6, for example. In the example shown in

FIG. 6, if the safety of the battery 5 falls under the category of “normal”, and the diagnosis result is within the permissible range, the control instruction generation unit 21 and the charge and discharge control unit 16 cause the battery 5 to be charged at the charging rate of Qa under the charging voltage upper limit of Va. Furthermore, the control instruction generation unit 21 and the charge and discharge control unit 16 cause the battery 5 to be discharged at the output power Pa from the battery 5. If the safety of the battery 5 falls under the category of “caution”, the control instruction generation unit 21 and the charge and discharge control unit 16 cause the battery 5 to be charged at the charging rate of Qb, which is smaller than Qb, and under the charging voltage upper limit of Vb, which is smaller than Va. Then, the instruction generation unit 21 and the charge and discharge control unit 16 cause the battery 5 to be discharged at the output power of Pb, which is smaller than Pa, from the battery 5. If the safety of the battery 5 falls under the category of “warning”, the control instruction generation unit 21 and the charge and discharge control unit 16 instructs a cessation of the charge and discharge of the battery 5.

The control instruction generation unit 21 may generate a control instruction based on, in addition to the diagnosis result of deterioration state of the battery 5, the control instruction generated at the previous diagnosis of the deterioration state of the battery 5 and an amount of change in the internal states and/or the battery characteristics of the battery 5 from the previous deterioration state diagnosis. In this case, the charge and discharge of the battery 5 is controlled based on, in addition to the diagnosis result of the deterioration state of the battery 5, the control instruction generated at the previous diagnosis of the deterioration state of the battery 5 and an amount of change in the internal states and/or battery characteristics of the battery 5 from the previous deterioration state diagnosis.

In one example, even if the safety of the battery 5 falls under the category of “normal” in the deterioration state diagnosis based on the criteria data, provided that one of the internal states or the battery characteristics of the battery 5 has changed by a degree exceeding the normal range since the previous deterioration state diagnosis, the control instruction generation unit 21 generates an instruction to suppress an electric current flowing in a battery and a power output from the battery during discharging, etc. For example, if either the positive electrode capacitance or the negative electrode capacitance has been reduced by a degree exceeding a predetermined threshold since the previous deterioration state diagnosis, the control instruction generating unit 21 determines that the change of the internal state of the battery 5 since the previous deterioration state diagnosis exceeds a normal range.

The control instruction generation unit 21 may generate a control instruction based on how the battery 5 has been used (use history) since the previous deterioration state diagnosis, in addition to the above-described matters. Furthermore, the charge and discharge of the battery 5 is controlled based on how the battery 5 has been used since the previous deterioration state diagnosis, in addition to the above-described matters. In one example, even if the safety of the battery 5 falls under the category of “normal” in the deterioration state diagnosis based on the criteria data, in the case where the nature of the use of the battery 5 since the previous deterioration state diagnosis is outside the normal range, the control instruction generation unit 21 generates an instruction to suppress an electric current flowing in the battery being charged and a power output from the battery during discharging, etc. For example, if an excessively large current has been flown in the battery 5 during a period longer than a predetermined period between the previous diagnosis and the present diagnosis, the control instruction generation unit 21 determines that the nature of the use the battery 5 does not fall within the normal range.

When one of the internal states or the battery characteristics of the battery 5 has changed by a degree exceeding the normal range since the previous deterioration state diagnosis, the control instruction generation unit 21 may update the criteria data serving as criteria for the relationship of the deterioration state of the battery 5 with respect to the one or more diagnosis items (deterioration map). Thus, the criteria data stored in the criteria data storage unit 22 is updated. At this time, the control instruction generation unit 21 updates the criteria data based on the estimated internal states and battery characteristics of the battery 5, and the changes in the internal states and battery characteristics since the previous diagnosis.

In one example, the deterioration state diagnosis of the battery 5 is conducted in the above-described manner, using the criteria data shown in FIG. 3. In this example, however, if the negative electrode capacitance has been reduced by a degree exceeding a predetermined threshold since the previous deterioration state diagnosis, the control instruction generation unit 21 updates, from what is shown in FIG. 3, the criteria data indicating the relationship of the deterioration state with respect to the negative electrode capacitance retention ratio, which is one of the diagnosis items. For example, in the data shown in FIG. 3 (the criteria data before being updated), 85% of the negative electrode capacitance retention ratio is the boundary between “normal” and “caution” in regard to the safety; on the other hand, in the updated criteria data, 86% is the boundary between “normal” and “caution”.

The threshold of the diagnosis item corresponding to the end time of the life span of the battery 5 may be updated through the updating of the criteria data. In one example, if the negative electrode capacitance has been reduced by a degree exceeding a predetermined threshold since the previous deterioration state diagnosis, the control instruction generation unit 21 updates the criteria data so as to change the threshold of the negative electrode capacitance corresponding to the end time of the life span of the battery 5. For example, in the criteria data before the updating, as shown in the example given in FIG. 4, a threshold of the negative electrode capacitance retention ratio corresponding to the end time of the life span of the battery 5 is set to 85%; on the other hand, in the updated criteria data, a threshold of the negative electrode capacitance retention ratio corresponding to the end time of the life span of the battery 5 is set to 86%.

When how the battery 5 has been used since the previous deterioration state diagnosis does not fall within the normal range, the control instruction generation unit 21 may update the criteria data serving as criteria for the relationship of the deterioration state of the battery 5 with respect to the one or more diagnosis items (deterioration map). Also in this case, the criteria data is updated, similarly to the case where one of the internal states or the battery characteristics of the battery 5 has changed by a degree exceeding the normal range since the previous deterioration state diagnosis.

In the user data storage unit 23, information about a plurality of users including the user of the battery-mounted device 2 is stored. For example, suppose the user, etc. of the battery-mounted device 2 is provided with the above-described service of diagnosing the deterioration state of the battery-mounted device 2 and outputting a control instruction in accordance with a diagnosis result of the deterioration state to the battery-mounted device 2. In this case, information, etc.

of the subscriber to the above-described service is stored in the user data storage unit 23. Furthermore, the control instruction generation unit 21 reads user information of the user of the battery-mounted device 2 from the user data storage unit 23 based on the identifier of the battery 5 or the battery-mounted device 2. Then, the control instruction generation unit 21 identifies the battery-mounted device 2 as a target for outputting a control instruction corresponding to the diagnosis result of the deterioration state, based on the user information regarding the user of the battery-mounted device 2.

The above-described service of diagnosing the deterioration state of the battery-mounted device 2 and outputting a control instruction in accordance with a diagnosis result of the deterioration state to the battery-mounted device 2 is provided by the administrator of the battery 5, who is not the user, etc. of the battery-mounted device 2. The provider of the above-described service may be the same as or different from the provider of the battery-mounted device 2 to the user. If the battery-mounted device 2 is a smart phone, any one of a carrier of the smart phone, a manufacturer of the smart phone, or a provider of an application that causes the controller 10 to conduct a deterioration state diagnosis, may be a provider of the above-described service. If the battery-mounted device 2 is a vehicle, any one of a manufacturer of the vehicle, a retailer of the vehicle, or a maintenance service provider of the vehicle different from the retailer, may be a provider of the above-described service. The manufacturer, etc. of the battery 5 may also be a provider of the above-described service.

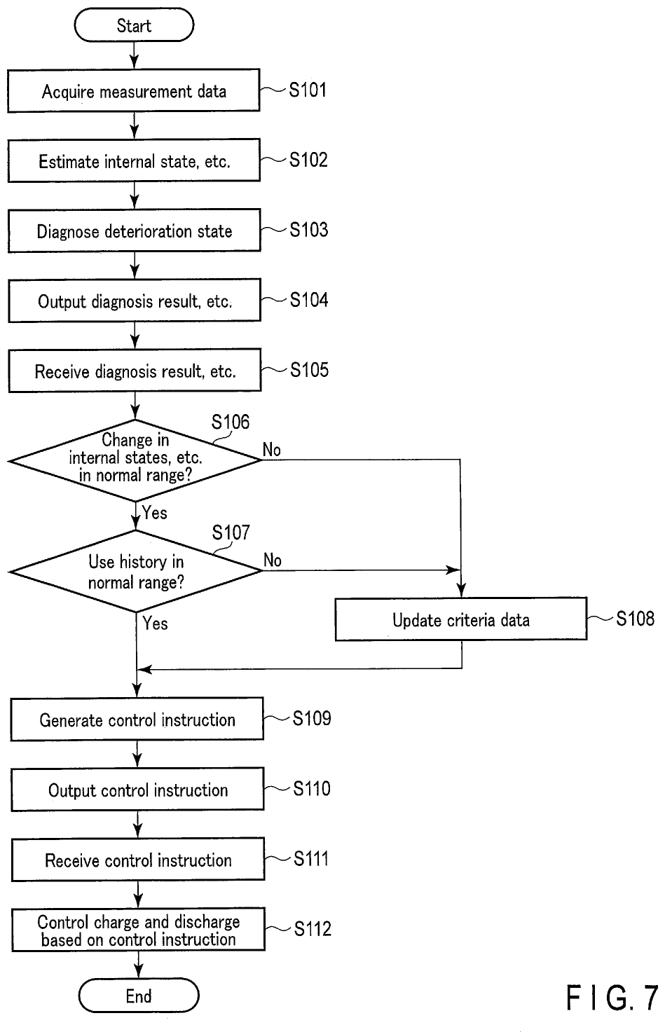

FIG. 7 is a flowchart illustrating an example of the processing performed by the controller of the battery-mounted device and the management server according to the first embodiment. The processing shown in FIG. 7 is periodically performed at predetermined timing. In one example, the processing shown in FIG. 7 is repeatedly performed at a predetermined interval, and in another example, the processing shown in FIG. 7 is performed upon input of an operation instruction by a user, etc. through a user interface of the battery-mounted device 2.

When the processing shown in FIG. 7 is commenced, the measurement data acquisition unit 11 of the controller 10 acquires the above-described measurement data of the parameters relating to the battery 5 (S101). Then, the internal state estimation unit 12 estimates the internal states and the battery characteristics of the battery 5 in the above-described manner, based on the measurement data (S102). Subsequently, the deterioration state diagnosis unit 15 diagnoses the deterioration state of the battery 5 based on the estimated internal states and battery characteristics of the battery 5 (S103). The deterioration state diagnosis unit 15 then outputs the diagnosis result of the deterioration state of the battery 5 to the management server 3 (outside the battery-mounted device 2) (S104).

Then, the control instruction generation unit 21 of the management server 3 receives a diagnosis result of the deterioration state, etc. (S105). The control instruction generation unit 21 determines whether or not the changes in the internal states and the battery characteristics of the battery 5 since the previous deterioration state diagnosis fall within the normal range based on the information, etc. received from the battery-mounted device 2 (S106), and determines whether or not how the battery 5 has been used since the previous deterioration state diagnosis falls within the normal range (S107). In either the case where one of the internal states or the battery characteristics of the battery 5 has changed by a degree exceeding the normal range since the previous deterioration state diagnosis (No in S106), or the case where how the battery 5 has been used since the previous deterioration state diagnosis falls outside the normal range (No in S107), the control instruction generation unit 21 updates the criteria data of the criteria data storage unit 22 in the above-described manner (S108). Thereafter, the processing proceeds to S109.

If the changes in any of the internal states and battery characteristics of the battery 5 since the previous diagnosis fall within the normal range (Yes in S106), and if how the battery 5 has been used since the previous diagnosis falls within the normal range (Yes in S107), the processing proceeds to S109, without updating the criteria data. Then, the control instruction generation unit 21 generates a control instruction regarding the charge and discharge of the battery 5 in correspondence to at least the diagnosis result of the deterioration state of the battery 5 (S109). If one of the internal states or the battery characteristics of the battery 5 has changed by a degree exceeding the normal range since the previous deterioration state diagnosis (No in S106), a control instruction corresponding to the estimated internal states and battery characteristics in addition to a diagnosis result of the deterioration state is generated. If how the battery 5 has been used since the previous diagnosis does not fall within the normal range (No in S107), a control instruction in correspondence to how the battery 5 has been used in addition to a diagnosis result of the deterioration state is generated.

The control instruction generation unit 21 then outputs the generated control instruction to the battery-mounted device (S110). The charge and discharge control unit 16 of the battery-mounted device 2 receives the control instruction from the management server 3 (S111). The charge and discharge control unit 16 then controls the charge and discharge of the battery 5 based on a received control instruction (S112).

In the present embodiment, the deterioration state diagnosis, such as the safety and the remaining life span diagnoses of the battery 5, is conducted in the above-described manner, and a diagnosis result of the deterioration state is output to the management server 3 from the battery-mounted device 2. It is thereby possible for the administrator, etc. of the battery 5, other than the user of the battery-mounted device 2, such as a provider of the battery-mounted device 2 to the user, to appropriately ascertain the deterioration state of the battery 5.

Furthermore, in the present embodiment, a control instruction regarding the charge and discharge of the battery in accordance with at least a diagnosis result of the deterioration state of the battery 5 is generated in the management server 3, and the generated control instruction is output to the battery-mounted device 2. The controller 10 of the battery-mounted device 2 then controls the charge and discharge of the battery 5 based on the control instruction received from the management server 3. It is thereby possible for an administrator, etc. of the battery 5 other than the user to have the user use the battery-mounted device 2 suitably given the current deterioration state of the battery 5. Thus, it is possible for the administrator, etc. of the battery 5, other than the user, to prevent the occurrence of safety problems pertaining to the battery 5 in advance.

### Second Embodiment

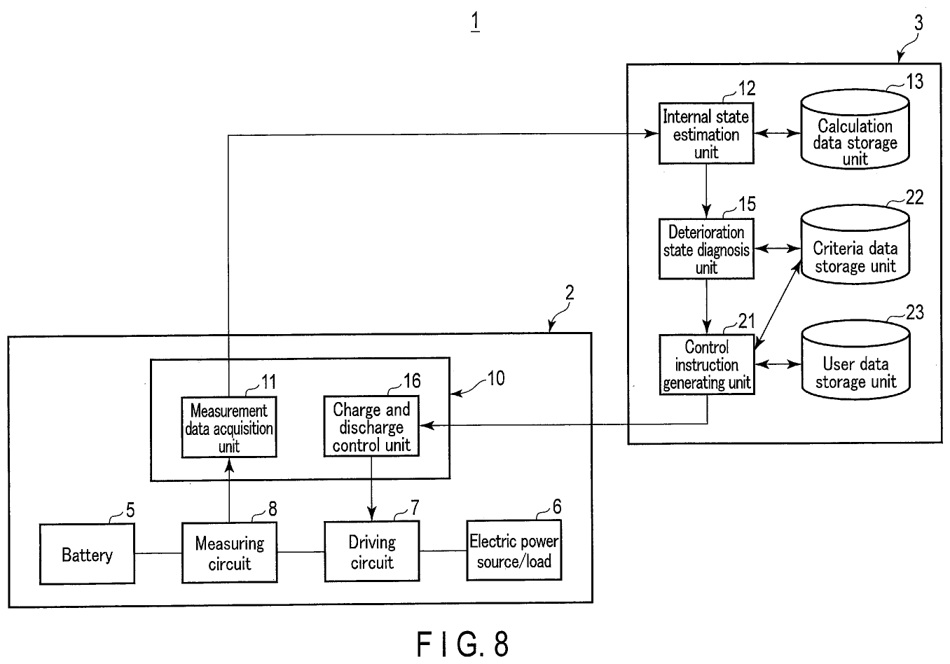

Next, the second embodiment will be described. In the description below, the configuration and processing changes from the first embodiment will be mainly described, and descriptions of the same configuration and processing as seen in the first embodiment will be omitted. FIG. 8 is a block diagram schematically showing a management system according to a second embodiment. As shown in FIG. 8, in the present embodiment, the internal state estimation unit 12, the calculation data storage unit 13, and the deterioration state diagnosis unit 15 are provided in the management server 3. In the present embodiment, not a diagnosis result of the deterioration state, measurement data of parameters relating to the battery 5 is output from the measurement data acquisition unit 11 to the management server 3 (outside the battery-mounted device 2). Then, the internal state estimation unit 12 of the management server 3 receives the measurement data, and estimates the internal states and the battery characteristics of the battery 5 based on the measurement data in a manner similar to the foregoing embodiment, etc. In the present embodiment, the deterioration state diagnosis of the battery 5 is performed by the deterioration state diagnosis unit 15 provided in the management server 3 in a manner similar to that of the foregoing embodiment, etc. The control instruction generation unit 21 then generates a control instruction regarding the charge and discharge of the battery 5 in correspondence to at least the diagnosis result of the deterioration state of the battery 5, in a manner similar to that of the foregoing embodiment, etc.

Also in the present embodiment, the control instruction generation unit 21 outputs the generated control instruction to the battery-mounted device 2, and the charge and discharge control unit 16 of the controller 10 of the battery-mounted device 2 receives the control instruction. In the present embodiment, the control instruction is output from the control instruction generation unit 21 to the charge and discharge control unit 16, as a response to the measurement data output to the management server 3. The charge and discharge control unit 16 controls the charge and discharge of the battery 5 based on the received control instruction. The calculation data storage unit 13, the criteria data storage unit 22 and the user data storage unit 23 may be provided in a computer separate from the controller 10 of the battery-mounted device 2 and the management server 3. In this case, the management server 3 is connected to the computer where the calculation data storage unit 13, the criteria data storage unit 22 and the user data storage unit 23, etc. are provided, via a network.

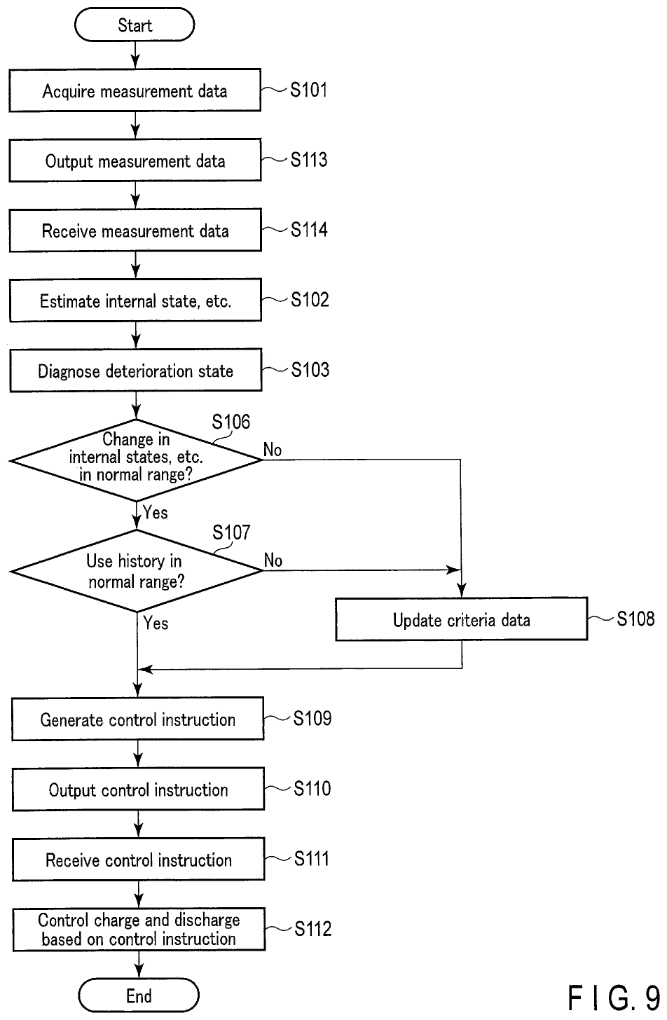

FIG. 9 is a flowchart showing an example of the processing performed by the controller of the battery-mounted device and the management server according to the second embodiment. The processing shown in FIG. 9 is periodically performed at predetermined timing, similarly to the processing shown in FIG. 7. When the processing shown in FIG. 9 is commenced, similarly to the processing shown in FIG. 7, the measurement data acquisition unit 11 of the controller 10 acquires the above-described measurement data of the parameters relating to the battery 5 (S101). In the present embodiment, however, when the processing in S101 is performed, the measurement data acquisition unit 11 outputs the measurement data, etc. to the management server 3 (outside the battery-mounted device 2) (S113). The internal state estimation unit 12 of the management server 3 then receives the measurement data, etc. (S114).

Similarly to the processing in FIG. 7, the internal state estimation unit 12 estimates the internal states and the battery characteristics, etc. of the battery 5 based on the measurement data (S102), and the deterioration state diagnosis unit 15 diagnoses the deterioration state of the battery 5 based on one of the estimated internal states and battery characteristics of the battery 5 (S103). Thereafter, the processing proceeds to S106. In the present embodiment, however, the processing in S102 and S103 is performed by the management server 3, not by the controller 10 of the battery-mounted device 2. In the processing shown in FIG. 9, the processing in S106 and thereafter is performed in a manner similar to the processing shown in FIG. 7.

Accordingly, the operations and advantageous effects similar to those of the first embodiment, etc. are achieved in the present embodiment. In other words, the deterioration state of the battery can be appropriately ascertained by the battery administrator, etc. (other than the user of the battery-mounted device).

### Modifications

In one modification, the internal state estimation unit 12 is provided in the controller 10 of the battery-mounted unit 2, and the deterioration state diagnosis unit 15 is provided in the management server 3. In the present modification, the internal states and the battery characteristics of the battery 5 are estimated by the controller 10 of the battery-mounted device 2. In the present modification, the controller 10 (internal state estimation unit 12) outputs an estimation result of the internal states and the battery characteristics to the management server 3 (outside the battery-mounted device 2). Then, the deterioration state diagnosis unit 15 of the management server 3 receives an estimation result of the internal state, etc., and diagnoses the deterioration state of the battery 5 based on the estimated internal state, etc.

In the present embodiment, the controller 10 and the management server 3 perform the same processing as that in the foregoing embodiment, etc., except for the above-described processing, etc. Accordingly, the operations and advantageous effects similar to those of the foregoing embodiment, etc. are achieved in the present modification.

In at least one of the foregoing embodiments and examples, with the charge and discharge control method, a control instruction relating to the charge and discharge of a battery corresponding to at least a diagnosis result of a deterioration state of the battery based on the measurement data, is received from the outside of the battery-mounted device. The charge and discharge of the battery is then controlled based on the received control instruction. Thus, it is possible for a battery administrator, etc. (other than a user of the battery-mounted device) to appropriately ascertain a deterioration state of the battery, and to prevent occurrence of problems in the safety of the battery in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A charge and discharge control method comprising:
acquiring measurement data regarding a parameter relating to a battery of a battery-mounted device at the time of battery charge or discharge;
receiving, from the outside of the battery-mounted device, a control instruction relating to the battery charge and discharge corresponding at least to a diagnosis result of a deterioration state of the battery based on the measurement data; and
controlling charge and discharge of the battery based on the received control instruction.

2. The charge and discharge control method according to claim 1, the method further comprising:
estimating an internal state and a battery characteristic of the battery based on the measurement data;
diagnosing the deterioration state of the battery based on either the estimated internal state or the battery characteristic; and
outputting the diagnosis result of the deterioration state to the outside of the battery-mounted device, wherein
the control instruction is received as a response to the output diagnosis result.

3. The charge and discharge control method according to claim 1, the method further comprising:
outputting the measurement data of the parameter relating to the battery to the outside of the battery-mounted device, wherein
the control instruction is received as a response to the output measurement data.

4. The charge and discharge control method according to claim 1, wherein
if the diagnosis result of the deterioration state exceeds a permissible range, based on the received control instruction,
one of an electric current flowing in the battery during charging, a voltage of the battery during charging, or a power output from the battery during discharging is suppressed in comparison to a case where the diagnosis result falls within a permissible range, or
a use of the battery is instructed to be stopped.

5. A battery-mounted device comprising:
a controller that performs the charge and discharge control method according to claim 1; and
the battery charge and discharge of which is controlled by the controller.

6. A management system comprising:
the battery-mounted device according to claim 5; and
a management server comprising a processor, wherein
the processor of the management server is configured to:
generate the control instruction corresponding to the diagnosis result of the deterioration state of the battery; and
output the generated control instruction to the battery-mounted device.

7. A non-transitory storage medium storing a charge and discharge control program causing a computer of the battery-mounted device to execute the charge and discharge control method according to claim 1.

8. A management method comprising:
acquiring a diagnosis result of a deterioration state of a battery in a battery-mounted device, based on measurement data regarding a parameter relating to the battery at the time of battery charge or discharge;
generating a control instruction relating to the charge and discharge of the battery corresponding to at least the diagnosis result of the deterioration state; and
outputting the generated control instruction to the battery-mounted device.

9. The management method according to claim 8, further comprising
receiving the diagnosis result of the deterioration state from the battery-mounted device, wherein
the control instruction is output as a response to the received diagnosis result.

10. The management method according to claim 8,
further comprising:
receiving the measurement data of the parameter relating to the battery from the battery-mounted device,
estimating an internal state and a battery characteristic of the battery based on the measurement data;
diagnosing the deterioration state of the battery based on either the estimated internal state or the estimated battery characteristic of the battery, wherein
the control instruction is output as a response to the received measurement data.

11. The management method according to claim 8, wherein
if the diagnosis result of the deterioration state exceeds a permissible range, as the control instruction,
an instruction to suppress, in comparison to a case where the diagnosis result falls within the permissible range, an electric current flowing in the battery during charging, a voltage of the battery during charging, or a power output from the battery during discharging, is generated, or
an instruction to stop a use of the battery is generated.

12. The management method according to claim 8, further comprising:
acquiring either an internal state or a battery characteristic of the battery which is estimated based on the measurement data of the parameter relating to the battery; and
updating criteria data which serves as criteria for a relationship of the deterioration state of the battery with respect to diagnosis items of the diagnosis of the deterioration state, based on at least one of the estimated internal state or battery characteristics of the battery.

13. The management method according to claim 8, further comprising:
acquiring user information relating to a user of the battery-mounted device; and
identifying, based on the user information, the battery-mounted device as a target for outputting the control instruction corresponding to the diagnosis result of the deterioration state.

14. A management server that includes a processor that executes the management method according to claim 8.

15. A non-transitory storage medium storing a management program causing an external computer of the battery-mounted device to execute the management method according to claim 8.
